(19) United States
(12) Patent Application Publication
(10) Pub. No.: US 2019/0260221 A1
(43) Pub. Date: Aug. 22, 2019

(54) Solar Charger

(71) Applicants: Judy Maloney, Tampa, FL (US); James Maloney, Tampa, FL (US)

(72) Inventors: Judy Maloney, Tampa, FL (US); James Maloney, Tampa, FL (US)

(21) Appl. No.: 15/902,944

(22) Filed: Feb. 22, 2018

(51) Int. Cl. H02J 7/35; H02J 7/00

(52) U.S. Cl. CPC H02J 7/355; H02J 7/0054

(57) ABSTRACT

The present invention is a charging device with solar cells wrap around it and that houses electronics plug in ports for various devices. The charging device has a rectangular base with a top that has solar panels on it. The panels will create electricity using solar power which is used to either charge a rechargeable battery or to power an electronic device. The device would have charging ports on the front with a plane back. The charging device can be placed on a dashboard or a car or vehicle.

### CROSS-REFERENCES TO RELATED APPLICATIONS (IF ANY)

None

### BACKGROUND

### 1. Field of the Invention

The invention relates to a device with solar cells wrap around it and that houses electronics plug in ports for various devices.

### 2. Description of Prior Art

Sometime people are stuck in storms or traveling without a power source for their electronic devices. In today's world, people have their whole life on their phones and electronic devices. They need to be able to charge them when they do not have any standard power sources.

There is still room for improvement in the art.

### SUMMARY OF THE INVENTION

The present invention is a charging device with solar cells wrap around it and that houses electronics plug in ports for various devices.

The charging device has a rectangular base with a top that has solar panels on it. The panels will create electricity using solar power. This electric power is used to either charge a rechargeable battery or to power an electronic device. The device would have charging ports on the front with a plane back. The charging device can be placed on a dashboard or a car or vehicle.

The current invention is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows a front top view of the charger;

FIG. 2 shows a front view of the charger;

FIG. 3 shows the back of the charger; and

FIG. 4 show the battery connected to the solar panels.

### DESCRIPTION OF THE PREFERRED EMBODIMENT

There are a number of significant design features and improvements incorporated within the invention.

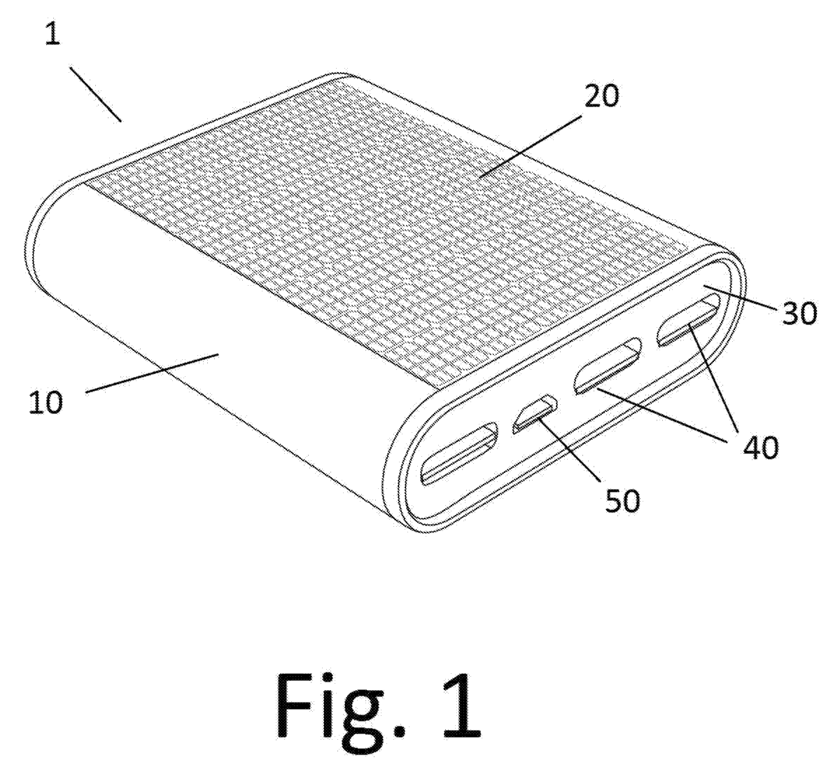

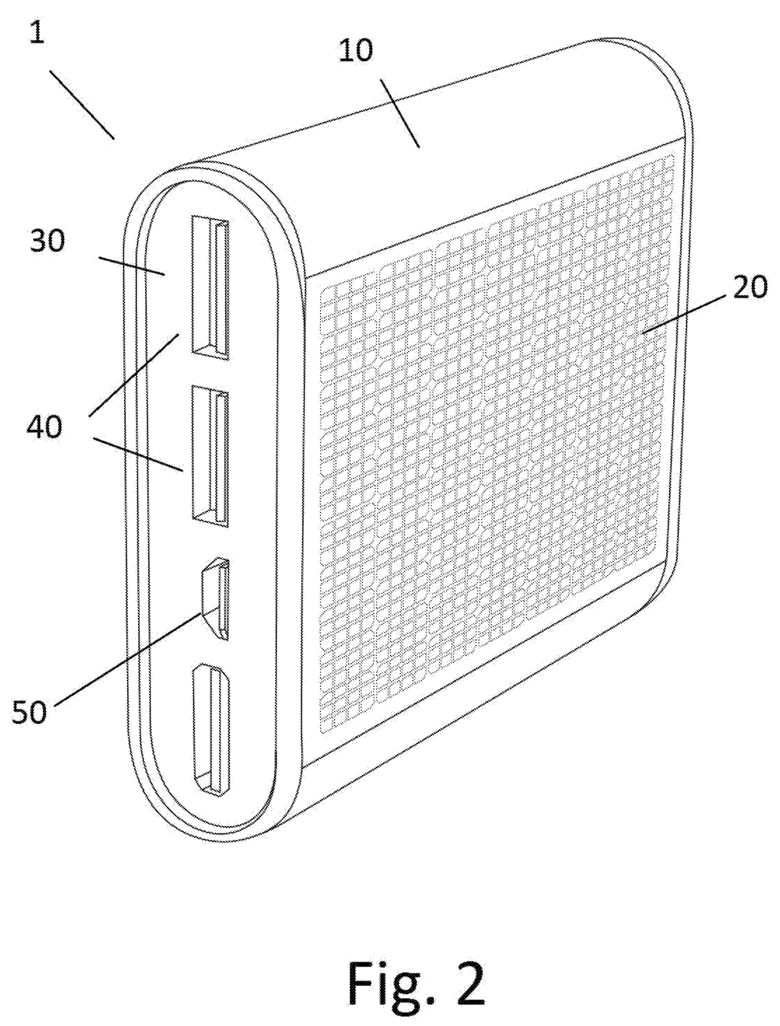

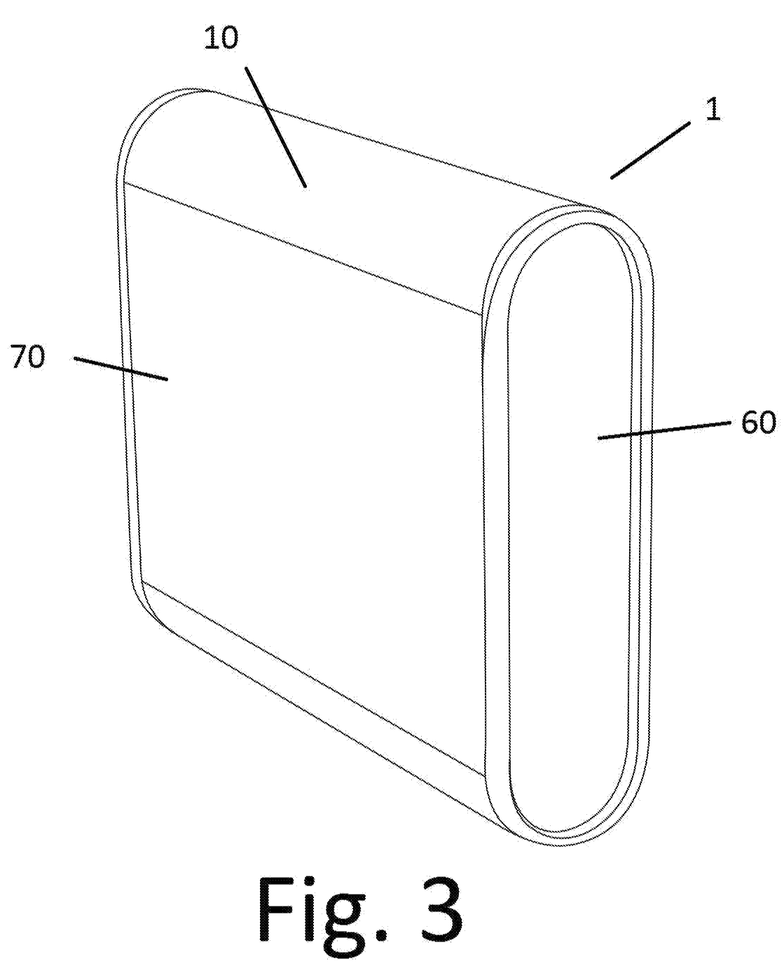

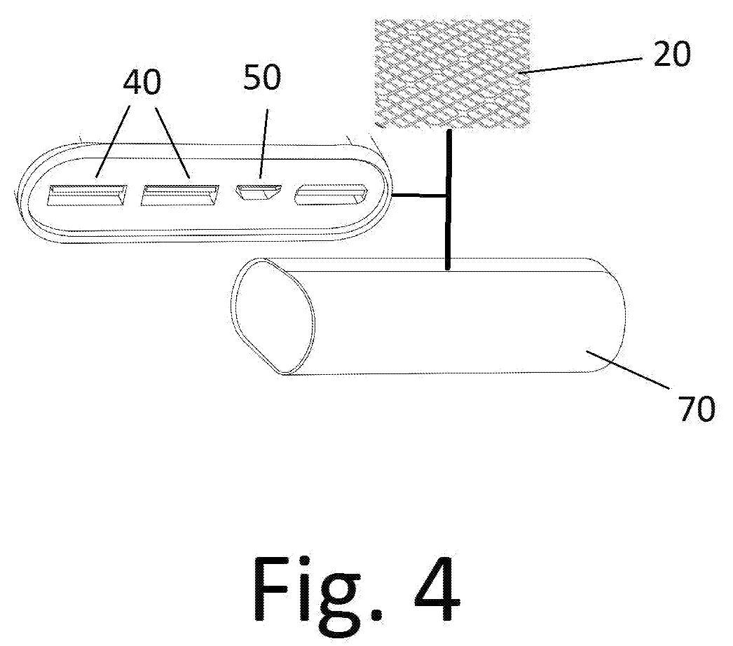

As shown in FIGS. 1 through 4, the present invention is a charging device 1.

The charging device 1 has a rectangular base 10 with rounded sides. The top of the base 10 has a plurality of solar panels 20. The panels 20 will create electricity using solar power. This electric power is used to either charge a rechargeable battery 70 and/or to power an electronic device through a plurality of charge ports located on the front 30 of the base 10.

The device 1 would have charging ports 40 including one or more USB charging port 50 on the front 30 of the base 10. In the preferred embodiment, the base 10 would have a plane back 60 with a flat bottom 70. The flat bottom 70 allows the charging device 1 to be placed on any semi-flat surface such as a dashboard on a car or vehicle.

Operation

The charging device 1 would be placed in the sun light where the solar panels would convert the sun light into electricity. This electricity would either be stored in the rechargeable battery 70 or provide electricity to the charging ports 40. The charging ports 40 can also draw electricity from the battery 70 when needed such as night time or if the electricity draw is too much for the solar panels 20 to provide at one time.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A charging device comprising:
A base with a top, bottom, back and front with a plurality of solar panels on the top of said base where the solar panels provided electricity for a plurality of charging ports.

2. The charging device according to claim 1 comprising:
Having the charging ports on the front of said base.

3. The charging device according to claim 1 comprising:
Having a flat bottom.

4. The charging device according to claim 1 comprising:
Having a rechargeable battery.

5. The charging device according to claim 4 comprising:
Having the solar panels charge the battery.

6. The charging device according to claim 5 comprising:
Having the battery connected to the charging ports and having the charging ports draw electricity from the battery.
